(19) United States
(12) Patent Application Publication
(10) Pub. No.: US 2004/0095562 A1
(43) Pub. Date: May 20, 2004

(54) Combination scanner/projector

(76) Inventor: John Moffatt, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/300,100

(22) Filed: Nov. 20, 2002

(51) Int. Cl. G03B 21/00

(52) U.S. Cl. 353/122

(57) ABSTRACT

A combination scanning and digital projector device including a scanning assembly connected to an input/output control device for capturing a scanned image of a document, a processing device connected to the input/output control device for processing digital image data representative of a scanned image and an image projection subassembly connected to the input/output control device for projecting digital image data.

### BACKGROUND OF THE INVENTION

1. Technical Field

The present invention relates to image processing and more particularly to a device for scanning and projecting an image.

2. Background Art

Live and/or recorded performances including for instance lectures, seminars, sales, marketing and team or group meetings and the like, often include the presentation of visual materials. When using a conventional overhead projector to present such material, each page is typically printed on a plastic transparency, and then projected on a conventional overhead projector. This system of presentation has limitations, for instance, if an exhibit or other visual material is deemed relevant to a presentation at a relatively late point in time relative to the presentation or perhaps even during the presentation. In such instances, a presenter may have to decide to eliminate the material from the presentation, distribute the information in an alternate format or, in the alternative, possibly prepare transparencies at the “last minute”.

There may be an advantage found in providing a combination projector and digital scanning device that scans an object, for example a document, processes the scanned image to provide data representative of the scanned image and projects the processed image for viewing on a surface.

Additionally, there may be an advantage found in providing a combination projector and digital scanning device that scans an object, for example a document, processes the scanned image to provide data representative of the scanned image and, in addition to projecting the processed image for viewing on a surface, would be capable of printing the image to a media. A presenter may then be allowed not only to display the scanned image but also to disseminate copies if desired to participants or the like.

Additionally, there may be an advantage found in providing a combination projector and digital scanning device that permits connection of the device to a network through a connected personal computer in order to provide access to a broad range of data.

### SUMMARY OF THE INVENTION

The present invention is directed to a combination scanner/projector. The combination scanner/projector includes at least one video port connectable to a computer for receiving image data to be projected, a scanning subsystem for capturing image data, a memory coupled to the video port and the scanning subsystem for storing the image data. An image projection subsystem is connected to the memory for projecting stored image data. The video port may be configured as an analog or a digital port, for example VGA, XGA, as well as RCA, S-video, component video or the like.

The present invention consists of the device and system hereinafter more fully described, illustrated in the accompanying drawings and more particularly pointed out in the appended claims, it being understood that changes may be made in the form, size, proportions and minor details of construction without departing from the spirit or sacrificing any of the advantages of the invention.

### BRIEF DESCRIPTION OF THE DRAWINGS

FIG. 1 is a representative perspective view of a projection system including a combination scanner/projector, according to one embodiment;

FIG. 2 is a schematic representation of a combination scanner/projector according to one embodiment;

FIG. 3 is a schematic representation of a combination scanner/projector according to one embodiment; and

FIG. 4 is a schematic flow chart representation of a combination scanner/projector according to one embodiment.

### DESCRIPTION OF THE PREFERRED EMBODIMENT

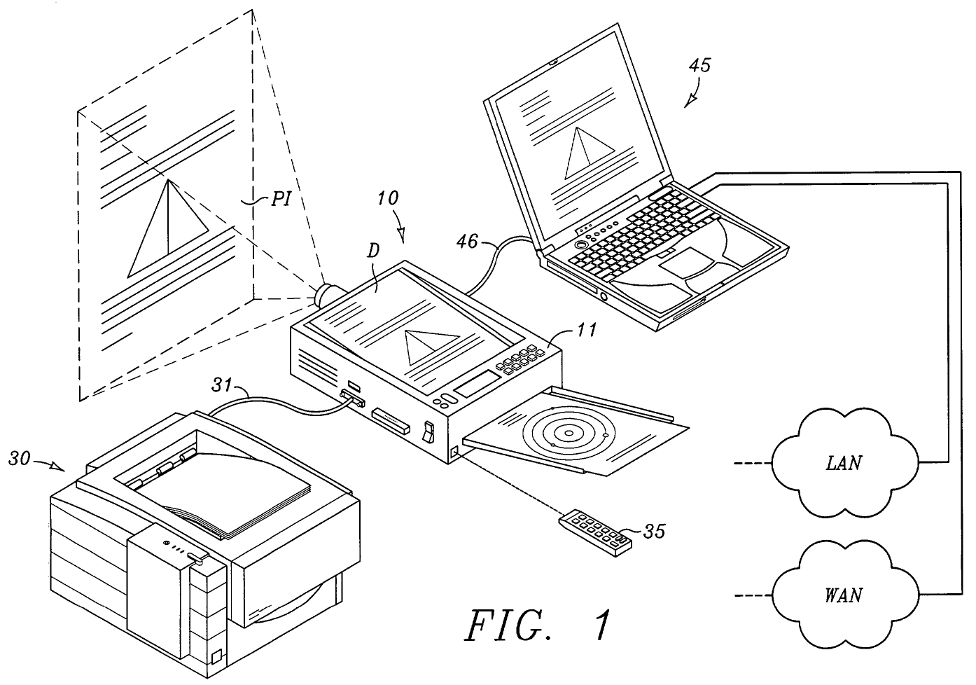

Referring to FIG. 1, combination scanner/projector 10 is shown including housing 11 which provides an enclosure for various component parts of combination scanner/projector 10. Combination scanner/projector 10 is shown connected to personal computer 45 which in turn provides additional processing and connectivity capability via connection to local area network LAN and/or wide area network WAN. While personal computer 45 is shown connected to combination scanner/projector 10 by means of cable 46, it is to be distinctly understood that the invention described herein is not intended to be limited by the means of connectivity between personal computer 45 and combination scanner/projector 10 and that such connection may be achieved by any wired or wireless means known to those skilled in the art, for instance infrared, microwave or radio wave may all be used to effect such connection.

As shown in FIG. 1, combination scanner/projector 10 may also be connected to additional output devices such as imaging device 30. FIG. 1 shows imaging device 30 connected via cable 31 although again, it is to be distinctly understood that the invention is not intended to be limited by the means of connectivity between imaging device 30 and combination scanner/projector 10 and that such connection may be achieved by any wired or wireless means known to those skilled in the art, for instance infrared, microwave or radio wave may all be used to effect such connection.

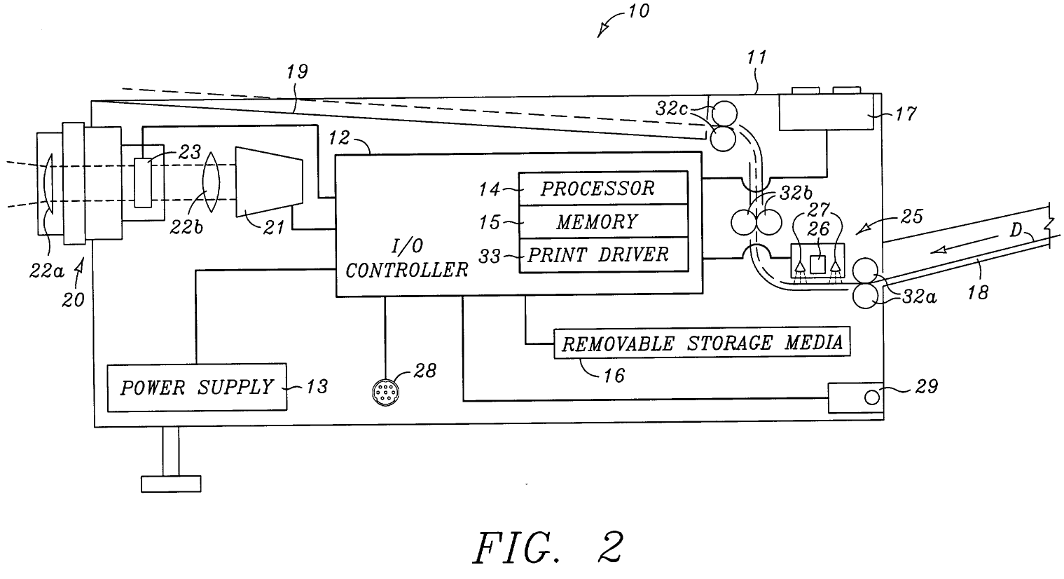

Referring to FIG. 2, one preferred embodiment of combination scanner/projector 10 is shown to advantage including housing 11. Power supply 13 is positioned within housing 11 and provides electrical power for the various assemblies and components of scanner/projector 10. Input/output controller 12 including processor 14 and memory 15 are shown located within housing 11. As shown, combination scanner/projector 10 also includes print driver 33 and removable storage media 16. Scanner/projector also includes control device 17 which is shown configured as a panel integrated within housing 11 and connected to input/output controller 12.

Control device 17 provides a user interface for operating various device functions. Remote control 35, shown in FIG. 1, may be employed to control various functions of combination scanner/projector 10 including initiation of a scanning cycle, selection of data image source and projection of stored image data.

Combination scanner/projector 10 may also include a document feed assembly including input tray 18, output tray 19 and motorized feed rollers 32a, 32b and 32c. Scanning subassembly 25 is connected to and controlled by input/output controller 12. Document D is transported by transport rollers 32a, 32b and 32c from input tray 18 past scanning subassembly 25 and data representative of an image of document D is captured by scanning subassembly 25. Document D continues transport by transport rollers 32a, 32b and 32c to output tray 19. Scanning subassembly 25 includes photo sensor 26 and illumination sources 27. Photo sensor 26 may be configured as a CCD or CMOS sensor or array. Photo sensor 26 may include grayscale or color data image capability. Photo sensor 26 produces data including a digital image of document D. Scanning subassembly 25 may include capability for scanning both opaque and transparent documents.

Output from photo sensor 26 is converted from an analog to a digital signal and transmitted to processor 14 of input/output controller 12 where data augmentation may occur by operation of various known algorithms for color character recognition, color enhancement or correction, data compression or the like. Data representative of an image of document D may then be stored to memory 15 or to removable storage media 16.

In one embodiment, combination scanner/projector 10 also includes image projection subassembly 20. Image projection subassembly 20 includes a projection light source 21, optical elements 22a and 22b for focusing light and image modulation device 23. Projection light source 21 and image modulation device 23 are connected to and are controlled by input/output controller 12. Light from projection light source 21 passes through optical element 22b and is focused so that it projects through image modulation device 23. Image modulation device 23 may be configured as a liquid crystal display type modulation device or in the alternative as a reflective type modulation device. Image modulation device 23 attenuates or reflects light or color, depending on the type of device, generating a visible image representative of document D. Light exiting image modulation device 23 is focused via optical element 22a and projected as projected image P1, shown in FIG. 1.

As shown in FIG. 2, combination scanner/projector 10 includes video port 28 which enables the conductive interface of combination scanner/projector 10 with a variety of peripheral devices for input or output. Video port 28 may be configured as an analog or a digital port, for example VGA, XGA, as well as RCA, S-video, component video or the like. Combination scanner/projector 10 may also include wireless communications port 29 which permits the transmission of data by a wireless signal.

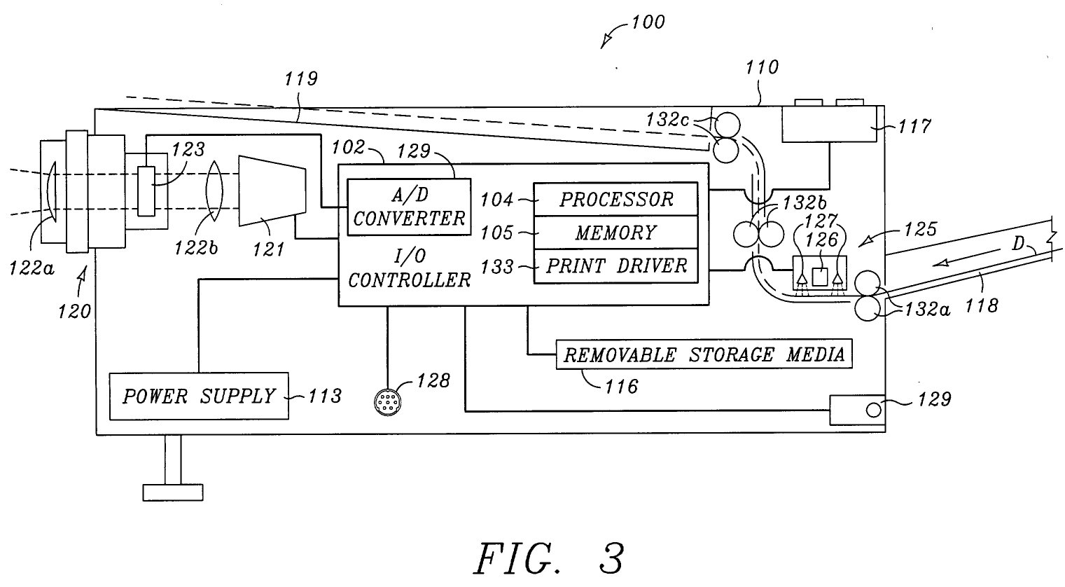

Referring to FIG. 3, an alternate preferred embodiment of combination scanner/projector 100 is shown to advantage including housing 110. Power supply 113 is positioned within housing 110 and provides electrical power for the various assemblies and components of scanner/projector 100. Input/output controller 102 including processor 104 and memory 105 are shown located within housing 101. As shown, combination scanner/projector 100 also includes print driver 133 and removable storage media 116. Scanner/projector 100 also includes control device 117 which is shown configured as a panel integrated within housing 101 and connected to input/output controller 102. Control device 117 provides a user interface for operating various device functions.

Combination scanner/projector 100 also includes document feed assembly including input tray 118, output tray 119 and motorized feed rollers 132a, 132b and 132c. Scanning subassembly 125 is connected to and controlled by input/output controller 102. Document D is transported by transport rollers 132a, 132b and 132c from input tray 118 past scanning subassembly 125 and data representative of an image of document D is captured by scanning subassembly 125. Document D continues transport by transport rollers 132a, 132b and 132c to output tray 119. Scanning subassembly 125 includes photo sensor 126 and illumination sources 127. Photo sensor 126 produces digital image data of document D.

Output from photo sensor 126 is converted from an analog to a digital signal and transmitted to processor 104 of input/output controller 102 where data augmentation may occur by operation of various known algorithms for color character recognition, color enhancement or correction, data compression or the like. Data representative of an image of document D may then be stored to memory 105 or to removable storage media 116.

In the embodiment shown in FIG. 3, combination scanner/projector 100 includes an analog image projection subassembly 120. In this embodiment, a signal output from input/output controller 102 is supplied to A/D converter 129, where digital data representative of an image of document D is converted to analog signals which are transmitted to projection medium 123.

In the embodiment shown in FIG. 3, image projection subassembly 120 includes projection light source 121, optical elements 122a and 122b for focusing light and projection medium 123. Projection light source 121 and image projection medium 123 are connected to and are controlled by input/output controller 102. Light from projection light source 121 passes through optical element 122b and is focused so that it projects through projection medium 123.

Light exiting projection medium 123 is focused via optical element 122a and projected as projected image Pi, shown in FIG. 1.

As shown in FIG. 3, combination scanner/projector 100 includes video port 128 which may be configured as an analog or a digital port, for example VGA, XGA, as well as RCA, S-video, component video or the like.

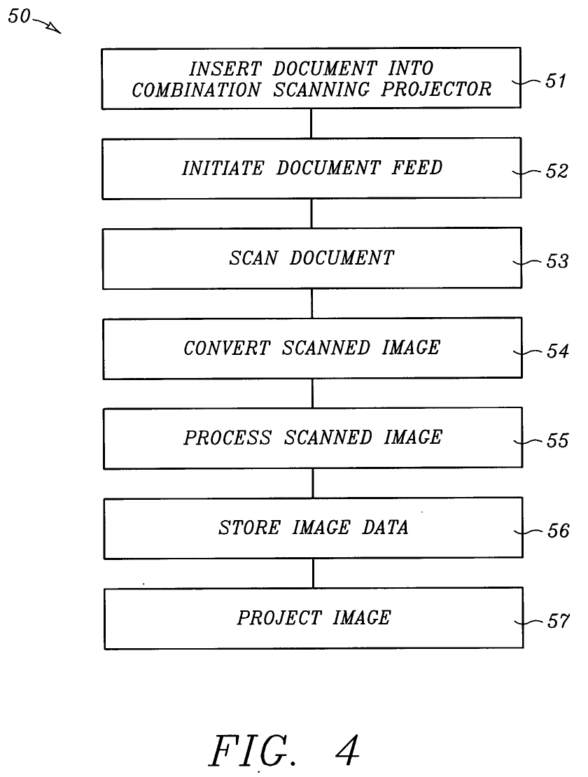

In use, as shown in FIG. 4, a method of scanning an image and projecting a digitally generated image 50 includes the steps of “Insert Document into Combination Scanner/projector” 51 where a document is inserted in the document feed of a combination scanner/projector. At “Initiate Document Feed” 52, the image bearing document is fed by means of a media transport assembly into the combination scanner/projector. Data including a digital image of an image bearing document is acquired at “Scan Document” 53. At “Convert Scanned Image” 54, output from the scanning subassembly is converted from an analog to a digital signal and transmitted to a processing device. At “Process Scanned Image” 55, data augmentation occurs by operation of various known algorithms for color character recognition, color enhancement or correction and data compression. Data representative of an image of document D may then be stored to memory at “Store Image Data” 56. At “Project Image” 57, data representative of an image and stored in data storage is projected by a digital image projection subassembly.

While this invention has been described with reference to the detailed embodiments, this is not meant to be construed in a limiting sense. Various modifications to the described embodiments as well as the inclusion or exclusion of additional embodiments will be apparent to persons skilled in the art upon reference to this description. It is therefore contemplated that the appended claims will cover any such modifications or embodiments as fall within the true scope of the invention.

What is claimed is:

1. A combination scanner/projector connectable to a computer, the combination scanner/projector comprising:
at least one video port connectable to the computer for receiving image data to be projected;
a scanning subsystem for capturing image data;
a memory coupled to the video port and the scanning subsystem for storing the image data; and
an image projection subsystem connected to the memory for projecting the stored image data.

2. The combination scanner/projector of claim 1 further comprising an input/output controller connected to the scanning subsystem and the image projection subsystem.

3. The combination scanner/projector of claim 1 further comprising a document feed assembly including a document transport assembly connected to the input/output control device for transporting a document across the scanning subassembly.

4. The combination scanner/projector of claim 2 further comprising a data storage device connected to the input/output controller for storing digital image data representative of a scanned image.

5. The combination scanner/projector of claim 2 further comprising a control device connected to the input/output controller for controlling operation of the combination scanning device and digital projector.

6. The combination scanner/projector of claim 2 further comprising a remote control device connected to the input/output controller for controlling operation of the combination scanning device and digital projector.

7. The combination scanner/projector of claim 2 further comprising a connectivity device connected to the input/output controller for enabling connection of the combination scanning device and digital projector to a peripheral device.

8. An imaging system comprising:
a combination scanning device and digital projector including an at least one video port connectable to a computer for receiving image data to be projected, a scanning subsystem for capturing image data, a memory coupled to the video port and the scanning subsystem for storing the image data and an image projection subsystem connected to the memory for projecting the stored image data.

9. The combination scanner/projector of claim 8 further comprising an input/output controller connected to the scanning subsystem and the image projection subsystem.

10. The combination scanner/projector of claim 8 further comprising a document feed assembly including an input tray connected to input/output controller including a document transport assembly connected to the input/output control device for transporting a document across the scanning subassembly.

11. The imaging system of claim 9 further comprising a data storage device connected to the input/output controller for storing digital image data representative of a scanned image.

12. The imaging system of claim 9 further comprising a control device connected to the input/output controller for controlling operation of the combination scanning device and digital projector.

13. The imaging system of claim 9 further comprising a remote control device connected to the input/output controller for controlling operation of the combination scanning device and digital projector.

14. The imaging system of claim 9 further comprising a connectivity device connected to the input/output controller for enabling connection of the combination scanning device and digital projector to a peripheral device.

15. The imaging system of claim 9 further comprising an imaging device connected to the input/output controller for providing a printed image of the digital image data.

16. The imaging system of claim 8 wherein the computer further comprises a connection to a network for providing access to digital image data stored on the network for projecting digital image data stored on the network.

17. A method for scanning an image and projecting a digitally generated image including the steps of:
inserting a document into a combination scanner/projector;
initiating a document feed function to transport the document through the combination scanner/projector;
capturing data representative of an image of the document by scanning the document with a scanning assembly;
converting the scanned image from an analog to a digital signal;
transmitting the digital signal to a processing device;
processing the digital signal to generate digital image data representative of an image of the document;
storing digital image data to a storage media of the combination scanner/projector; and
projecting a digital image data representative of an image of the document with a digital projection assembly.
